(19) United States
(12) Patent Application Publication
(10) Pub. No.: US 2015/0050236 A1
(43) Pub. Date: Feb. 19, 2015

(54) COMPOSITION FOR ATTRACTING MALE BLUEBERRY SPANWORM MOTH

(71) Applicant: Her Majesty the Queen in Right of Canada, as represented by the Minister of Natural Resource, Ottawa (CA)

(72) Inventors: Peter J. SILK, Fredericton (CA); Peter MAYO, Durham Bridge (CA); Neil Kirk HILLIER, Wolfville (CA); Gerald Christopher CUTLER, Salmon River (CA); Edirimuni Chaminda Amal DE SILVA, Etobicoke (CA); David MAGEE, Gagetown (CA)

(21) Appl. No.: 14/493,677

(22) Filed: Sep. 23, 2014

Related U.S. Application Data
(62) Division of application No. 13/967,194, filed on Aug. 14, 2013.

(51) Int. Cl. A01N 43/20; A01N 27/00

(52) U.S. Cl. CPC A01N 43/20; A01N 27/00
USPC 424/84

(57) ABSTRACT

A method of attracting male blueberry spanworm moths that includes placing a composition comprising Z,Z-(3R,4S)-cis-3,4-epoxy-6,9-heptadecadiene and Z,Z,Z-3,6,9-heptadecatriene suitably close to a field of having the male blueberry spanworm moths. Use of a composition that includes Z,Z-(3R,4S)-cis-3,4-epoxy-6,9-heptadecadiene and Z,Z,Z-3,6,9-heptadecatriene for attracting male blueberry spanworm. The components may be present in a ratio of between 5:1 (by mass) and about 20:1 (by mass).

### CROSS REFERENCE TO RELATED APPLICATIONS

This application is a divisional application of U.S. patent application Ser. No. 13/967,194 filed Aug. 14, 2013, the contents of which is incorporated herein by reference.

### FIELD

The present disclosure relates to a composition that includes Z,Z-(3R,4S)-cis-3,4-epoxy-6,9-heptadecadiene and Z,Z,Z-3,6,9-heptadecatriene for use in attracting male blueberry spanworm (Itame argillacearia) moths.

### BACKGROUND

Lowbush blueberry (Vaccinium angustifolium Aiton, syn. “wild blueberry”) is a deciduous perennial shrub found in many parts of northeastern North America. In the eastern provinces of Canada and in the state of Maine, fields of wild lowbush blueberry plants are intensively managed. In Canada, lowbush blueberries are commercially grown on over 55,000 ha of land. Since 2006, Canadian lowbush blueberry production has exceeded 52,000 tonnes and $86 million, making it a major horticultural commodity for the region.

Blueberry spanworm, Itame argillacearia Packard (Lepidoptera: Geometridae), ranges from Ontario to Nova Scotia, and in the United States from Maine to West Virginia. It is considered an important defoliator of lowbush blueberry, but I. argillacearia also feeds on highbush blueberries and cranberries. Localized patches of damage are common in lowbush blueberry fields and blueberry plants can be completely defoliated during severe outbreaks. Larvae emerge in late spring and feed on developing flower buds, blossoms, foliage and/or emerging shoots. Feeding typically continues from June to early July, after which time mature larvae pupate in the soil. Approximately two weeks later adult moths emerge, mate, and lay eggs on leaves or on the ground that hatch the following year.

Early detection and monitoring of I. argillacearia is important to minimize plant damage. Sweep netting for larvae is the only monitoring technique currently available. However, I. argillacearia infestations are often difficult to predict, and since action thresholds for this insect are low, population thresholds are often exceeded before they are detected by growers. Detection is often more problematic in vegetative fields that are essentially bare ground in late spring. The nocturnal feeding habits of I. argillacearia larvae also make it challenging to accurately estimate populations since sweep netting is most conveniently done during the day.

Incorporation of species-specific pheromone lures into traps has provided an inexpensive and indispensable tool for disruption of male orientation and mating, and/or insect pest sampling and detection in agriculture and forestry, including many species of Lepidoptera (Cardé and Bell, 1995; Jutsum and Gordon, 1989; McNeil, 1991; Witzgall et al., 2010). Alford and Diehl (1985) previously showed that female I. argillacearia moths emit a pheromone(s) that is attractive to male moths, with repercussions for their reproductive success. They suggested that pheromone traps could provide a useful tool to growers in controlling future outbreaks using mating disruption or mass trapping techniques and population management for this pest.

It is, therefore, desirable to provide a composition that attracts male I. argillacearia spanworm moths, with the aim of developing a tool for managing the reproduction of I. argillacearia moths.

### SUMMARY

It is an object of the present disclosure to provide a composition that attracts male I. argillacearia spanworm moths.

According to one aspect, there is provided a composition that includes: Z,Z-(3R,4S)-cis-3,4-epoxy-6,9-heptadecadiene; and Z,Z,Z-3,6,9-heptadecatriene, where the Z,Z-(3R,4S)-cis-3,4-epoxy-6,9-heptadecadiene and the Z,Z,Z-3,6,9-heptadecatriene are present in a ratio of between 5:1 (by mass) and about 20:1 (by mass).

The composition Z,Z-(3R,4S)-cis-3,4-epoxy-6,9-heptadecadiene and the Z,Z,Z-3,6,9-heptadecatriene may be present a ratio of between about 8:1 (by mass) and about 15:1 (by mass), such as a ratio of about 9:1 (by mass).

The composition may be for attracting a male blueberry spanworm moth, for disrupting blueberry spanworm moth mating, or both.

According to another aspect, there is provided a use of a composition that includes Z,Z-(3R,4S)-cis-3,4-epoxy-6,9-heptadecadiene and Z,Z,Z-3,6,9-heptadecatriene for attracting a male blueberry spanworm moth, for disrupting blueberry spanworm moth mating, or both.

The Z,Z-(3R,4S)-cis-3,4-epoxy-6,9-heptadecadiene and the Z,Z,Z-3,6,9-heptadecatriene may be present a ratio of between 5:1 (by mass) and about 20:1 (by mass), such as a ratio of between about 8:1 (by mass) and about 15:1 (by mass). In particular examples the Z,Z-(3R,4S)-cis-3,4-epoxy-6,9-heptadecadiene and the Z,Z,Z-3,6,9-heptadecatriene are present a ratio of about 9:1 (by mass).

According to a further aspect, there is provided a method of attracting male blueberry spanworm moths. The method includes: applying a composition comprising Z,Z-(3R,4S)-cis-3,4-epoxy-6,9-heptadecadiene and Z,Z,Z-3,6,9-heptadecatriene to at least a portion of a field, or suitably close to a field, having blueberry spanworm moths, eggs, larva, or any combination thereof.

The Z,Z-(3R,4S)-cis-3,4-epoxy-6,9-heptadecadiene and the Z,Z,Z-3,6,9-heptadecatriene may be present a ratio of between 5:1 (by mass) and about 20:1 (by mass), such as a ratio of between about 8:1 (by mass) and about 15:1 (by mass). In particular examples the Z,Z-(3R,4S)-cis-3,4-epoxy-6,9-heptadecadiene and the Z,Z,Z-3,6,9-heptadecatriene are present a ratio of about 9:1 (by mass).

According to still another aspect, there is provided a method of disrupting blueberry spanworm moth mating. The method includes: applying a composition comprising Z,Z-(3R,4S)-cis-3,4-epoxy-6,9-heptadecadiene and Z,Z,Z-3,6,9-heptadecatriene to at least a portion of a field, or suitably close to a field, having blueberry spanworm moths in an amount sufficient to disrupt a male blueberry spanworm moth's ability to locate an emitting female blueberry spanworm moth.

The Z,Z-(3R,4S)-cis-3,4-epoxy-6,9-heptadecadiene and the Z,Z,Z-3,6,9-heptadecatriene may be present a ratio of between 5:1 (by mass) and about 20:1 (by mass), such as a ratio of between about 8:1 (by mass) and about 15:1 (by mass). In particular examples the Z,Z-(3R,4S)-cis-3,4-epoxy-6,9-heptadecadiene and the Z,Z,Z-3,6,9-heptadecatriene are present a ratio of about 9:1 (by mass).

According to yet another aspect, there is provided a composition for attracting a male blueberry spanworm moth, for disrupting blueberry spanworm moth mating, or both. The composition includes: Z,Z-(3R,4S)-cis-3,4-epoxy-6,9-heptadecadiene; and Z,Z,Z-3,6,9-heptadecatriene.

The Z,Z-(3R,4S)-cis-3,4-epoxy-6,9-heptadecadiene and the Z,Z,Z-3,6,9-heptadecatriene may be present a ratio of between 5:1 (by mass) and about 20:1 (by mass), such as a ratio of between about 8:1 (by mass) and about 15:1 (by mass). In particular examples the Z,Z-(3R,4S)-cis-3,4-epoxy-6,9-heptadecadiene and the Z,Z,Z-3,6,9-heptadecatriene are present a ratio of about 9:1 (by mass).

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures.

FIGS. 1A and 1B show a synthetic scheme illustrating the synthesis of Z,Z-(3R,4S)-cis-3,4-epoxy-6,9-heptadecadiene and of Z,Z-(3S,4R)-3,4-epoxy-6,9-heptadecadiene.

FIG. 2 shows a synthetic scheme illustrating the synthesis of Z,Z,Z-3,6,9-Heptadecatriene.

FIG. 3 is a graph illustrating the mean trap catches of male I. argillacearia moths in traps with a variety of different compounds and compositions, including compositions according to the present disclosure.

FIG. 4 is a graph illustrating the mean trap catches of male I. argillacearia moths in traps with compositions according to the present disclosure, as well as control compositions.

### DETAILED DESCRIPTION

The present disclosure provides a composition that includes Z,Z-(3R,4S)-cis-3,4-epoxy-6,9-heptadecadiene; and Z,Z,Z-3,6,9-heptadecatriene, where the Z,Z-(3R,4S)-cis-3,4-epoxy-6,9-heptadecadiene and the Z,Z,Z-3,6,9-heptadecatriene are present in a ratio of between 5:1 (by mass) and about 20:1 (by mass).

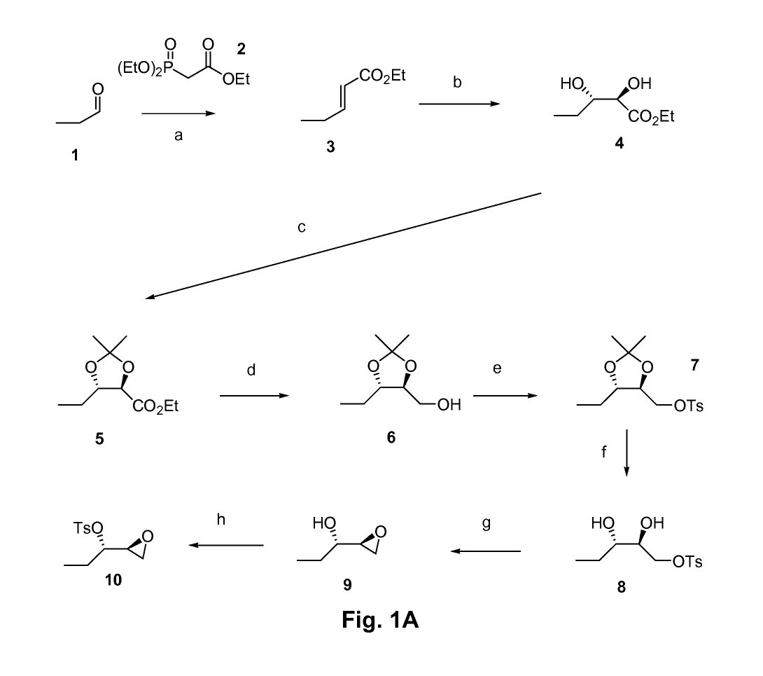

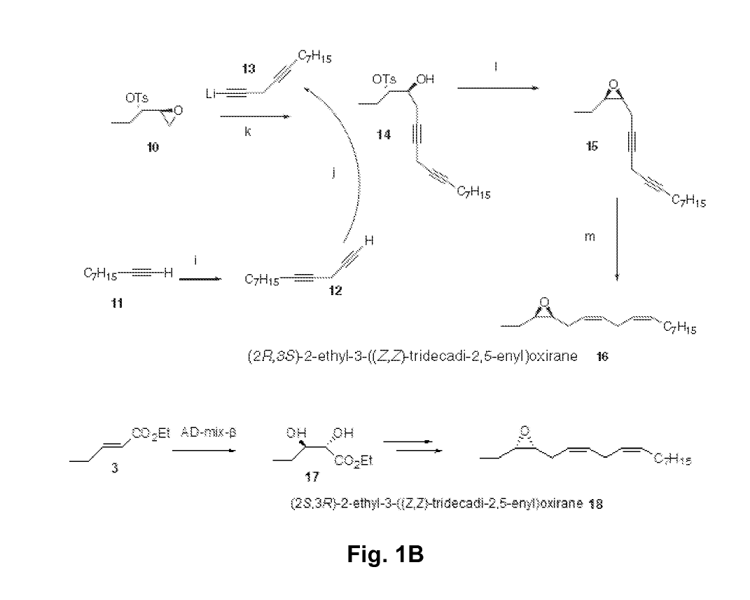

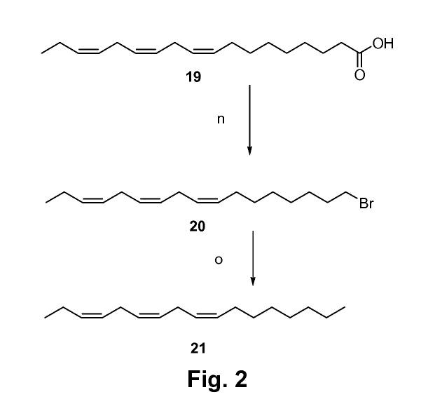

With regard to nomenclature, the term “heptadecatriene” may be abbreviated in the present disclosure as “(Z,Z,Z)-3,6,9-17:H”. Accordingly, the compound Z,Z-(3R,4S)-cis-3,4-epoxy-6,9-heptadecadiene (graphically illustrated in FIG. 1B as compound 16) may alternatively be referred to as (2R,3S)-2-ethyl-3-((Z,Z)-tridecadi-2,5-enyl) oxirane, or Z,Z-(3R,4S)-cis-3,4-epoxy-6,9-17:H, or 3R,4S-epoxy-(Z,Z)-6,9-17:H. The compound Z,Z,Z-3,6,9-heptadecatriene (graphically illustrated in FIG. 2 as compound 21) may alternatively be referred to as (Z,Z,Z)-3,6,9-17:H.

In particular examples, the Z,Z-(3R,4S)-cis-3,4-epoxy-6,9-heptadecadiene and the Z,Z,Z-3,6,9-heptadecatriene are present a ratio of between about 8:1 (by mass) and about 15:1 (by mass). In specific examples, the Z,Z-(3R,4S)-cis-3,4-epoxy-6,9-heptadecadiene and the Z,Z,Z-3,6,9-heptadecatriene are present in a ratio of about 9:1 (by mass).

The composition discussed above may be used for attracting male blueberry spanworm (Itame argillacearia) moths.

The present disclosure also provides a use of a composition that includes Z,Z-(3R,4S)-cis-3,4-epoxy-6,9-heptadecadiene and Z,Z,Z-3,6,9-heptadecatriene for attracting a male blueberry spanworm moth. The Z,Z-(3R,4S)-cis-3,4-epoxy-6,9-heptadecadiene and Z,Z,Z-3,6,9-heptadecatriene may be present in a ratio of between 5:1 (by mass) and about 20:1 (by mass). In particular examples, the Z,Z-(3R,4S)-cis-3,4-epoxy-6,9-heptadecadiene and the Z,Z,Z-3,6,9-heptadecatriene are present in a ratio of between about 8:1 (by mass) and about 15:1 (by mass). In specific examples, the Z,Z-(3R,4S)-cis-3,4-epoxy-6,9-heptadecadiene and the Z,Z,Z-3,6,9-heptadecatriene are present in a ratio of about 9:1 (by mass).

Additionally, the present disclosure provides a method for attracting male blueberry spanworm moths, where the method includes applying a composition comprising Z,Z-(3R,4S)-cis-3,4-epoxy-6,9-heptadecadiene and Z,Z,Z-3,6,9-heptadecatriene suitably close to a field of having the male blueberry spanworm moths. The Z,Z-(3R,4S)-cis-3,4-epoxy-6,9-heptadecadiene and Z,Z,Z-3,6,9-heptadecatriene may be present in a ratio of between 5:1 (by mass) and about 20:1 (by mass). In particular examples, the Z,Z-(3R,4S)-cis-3,4-epoxy-6,9-heptadecadiene and the Z,Z,Z-3,6,9-heptadecatriene are present in a ratio of between about 8:1 (by mass) and about 15:1 (by mass). In specific examples, the Z,Z-(3R,4S)-cis-3,4-epoxy-6,9-heptadecadiene and the Z,Z,Z-3,6,9-heptadecatriene are present in a ratio of about 9:1 (by mass).

It would be understood that the composition is “suitably close” to a field having the male blueberry spanworm moths if the male blueberry spanworm moths are able to detect the Z,Z-(3R,4S)-cis-3,4-epoxy-6,9-heptadecadiene and the Z,Z,Z-3,6,9-heptadecatriene and follow the pheromone trail.

The disclosure also provides a method of disrupting blueberry spanworm moth mating. Female blueberry spanworm moths emit an airborne trail (referred to as a pheromone plume) that includes Z,Z-(3R,4S)-cis-3,4-epoxy-6,9-heptadecadiene and Z,Z,Z-3,6,9-heptadecatriene, as discussed above. This specific mixture constitutes the blueberry spanworm moth's sex pheromone. Male blueberry spanworm moths use the information contained in the pheromone plume to locate the female blueberry spanworm moth emitting the pheromone plume. Different insect species emit different compounds, different mixtures of compounds, and/or different amounts of the same compounds, in order to avoid attracting males from another species. That is, different insect species have different sex pheromone signatures.

Mating disruption is a pest management technique that involves the use of sex pheromones to disrupt the reproductive cycle of insects. Mating disruption exploits the male blueberry spanworm moth's natural response to follow the pheromone plume by introducing pheromone unconnected to a female blueberry spanworm moth into the insects' habitat. The general effect of mating disruption is to confuse the male blueberry spanworm moths by masking the natural pheromone plumes, causing the males to follow “false pheromone trails” at the expense of finding mates, and affecting the males' ability to respond to “calling” females. Consequently, the male population experiences a reduced probability of successfully locating and mating with female blueberry spanworm moths.

Mating disruption may be achieved by applying a composition comprising Z,Z-(3R,4S)-cis-3,4-epoxy-6,9-heptadecadiene and Z,Z,Z-3,6,9-heptadecatriene to at least a portion of, or suitably close to, a field having blueberry spanworm moths, eggs, larva, or any combination thereof, in an amount sufficient to disrupt a male blueberry spanworm moth's ability to locate an emitting female blueberry spanworm moth.

The Z,Z-(3R,4S)-cis-3,4-epoxy-6,9-heptadecadiene and Z,Z,Z-3,6,9-heptadecatriene may be present in a ratio of between 5:1 (by mass) and about 20:1 (by mass). In particular examples, the Z,Z-(3R,4S)-cis-3,4-epoxy-6,9-heptadecadiene and the Z,Z,Z-3,6,9-heptadecatriene are present in a ratio of between about 8:1 (by mass) and about 15:1 (by mass). In specific examples, the Z,Z-(3R,4S)-cis-3,4-epoxy-6,9-heptadecadiene and the Z,Z,Z-3,6,9-heptadecatriene are present in a ratio of about 9:1 (by mass).

The composition may be applied to the portion of the field in any number of different ways. For example: the composition may be microencapsulated within polymer capsules, which may control the release rate of the Z,Z-(3R,4S)-cis-3,4-epoxy-6,9-heptadecadiene and Z,Z,Z-3,6,9-heptadecatriene; the composition may be applied by hand, such as by placing one or more dispensers or bait stations throughout the area to be protected; the composition may be applied using a flowable formulation to create long lasting monolithic pheromone dispenser; the composition may be applied though aerial dispersion.

The present disclosure also provides a composition for attracting a male blueberry spanworm moth, for disrupting blueberry spanworm moth mating, or both, the composition includes: Z,Z-(3R,4S)-cis-3,4-epoxy-6,9-heptadecadiene; and Z,Z,Z-3,6,9-heptadecatriene. The Z,Z-(3R,4S)-cis-3,4-epoxy-6,9-heptadecadiene and the Z,Z,Z-3,6,9-heptadecatriene may be present a ratio of between 5:1 (by mass) and about 20:1 (by mass), such as a ratio of between about 8:1 (by mass) and about 15:1 (by mass). In particular examples the Z,Z-(3R,4S)-cis-3,4-epoxy-6,9-heptadecadiene and the Z,Z,Z-3,6,9-heptadecatriene are present a ratio of about 9:1 (by mass).

### Materials and Method

Synthesis of Compounds.

The synthesis of the two epoxydiene enantiomers (16 and 18) was adapted from previously published elm spanworm Ennomos subsignaria (Hübner) study (Ryall et al., 2010). The synthetic scheme is illustrated in FIGS. 1A and 1B, where steps i-m are generally:

a) 2+NaH, THF, 0° C. to reflux.

b) AD-mix-α, t-BuOH, H₂O, methanesulfonamide, RT.

c) TsOH, (CH₃)₂C(OCH₃)₂, CH₂Cl₂, RT.

d) LiAlH₄, THF, RT.

e) TsCl, KOH, Et₂O, −10° C. to 0° C.

f) 1.25 M HCl in MeOH, RT.

g) K₂CO₃, MeOH, RT.

h) TsCl, KOH, Et₂O, 0° C.

i) 1. EtMgBr, THF, RT to 45° C., 2. CuI, −15° C., 3. propargyl bromide, −15° C. to RT.

j) 12+nBuLi, THF, −78° C.

k) 13+BF₃.Et₂O, THF, −78° C. to RT.

l) K₂CO₃, MeOH, RT.

m) Ni(OAc)₂4H₂O+NaBH₄+H_{2(g)}+(NH₂CH₂)₂, EtOH, 0° C.

The synthesis of Z,Z,Z-3,6,9-Heptadecatriene 21 is illustrated in FIG. 2, where steps n-0 are generally:

n) 1. (COCl)₂, DMF, DCM, reflux, 2. DMAP, 2-mercaptopyridine-N-oxide, sodium salt; CBrCl₃, reflux.

o) LiAlH₄, THF, reflux.

### Ethyl(E)-2-pentenoate 3

A flame-dried round-bottomed flask was charged with sodium hydride (570 mg, 60 wt % suspension in mineral oil, 14.3 mmol) and THF (25 mL), then cooled to 0° C. Triethylphosponoacetate (2) (2.80 mL, 14.1 mmol) was then added dropwise. The reaction was stirred at 0° C. for 10 min., then propanal (1) (0.92 mL, 12.8 mmol) was added dropwise and the mixture was heated to reflux for 16 h. The reaction was cooled to room temperature and 1:1 H₂O:EtOAc (50 mL) was added. The layers were separated and the aqueous layer was extracted with EtOAc (2×20 mL). The combined organic layers were washed with 1 M NaOH (20 mL), H₂O (20 mL) and brine (20 mL), then dried (MgSO₄). Column chromatography on silica gel (1:20 EtOAc:Hexanes) followed by concentration in vacuo yielded the ester 3 (848 mg, 6.63 mmol, 52%) as a colourless, transparent liquid. R_{f}=0.58 (1:6 EtOAc:Hexanes). Spectral data for 3: ¹H NMR (CDCl₃, 400 MHz): δ 7.03 (dt, 1H, J=15.7, 6.3 Hz), 5.82 (dt, 1H, J=15.6, 1.7 Hz), 4.19 (q, 2H, J=7.0 Hz), 2.23 (m, 2H), 1.29 (t, 3H, J=7.2 Hz), 1.07 (t, 3H, J=7.4 Hz). ¹³C NMR (CDCl₃, 100 MHz): δ 166.5, 150.2, 120.1, 59.9, 25.1, 14.0, 11.9. IR (neat, cm⁻¹): 2971 (m), 2937 (w), 2877 (w), 1717 (s), 1654 (m), 1461 (w), 1367 (m), 1333 (w), 1264 (s), 1179 (s), 1123 (w), 1043 (s). MS (EI, 70 eV): 55, 83 (base peak), 99, 100, 113, 128 (M⁺).

### Ethyl(2R,3S)-Dihydroxypentanoate 4

A round-bottomed flask was charged with AD-mix-α (22.2 g), H₂O (75 mL) and ^{t}BuOH (75 mL). After dissolution of the AD-mix-α, methanesulfonamide (1.44 g, 15.1 mmol) and ester 3 (1.94 g, 15.2 mmol) were added and the mixture was stirred at room temperature for 16 h. Na₂SO₃ (23.0 g, 182 mmol) was then added and the reaction was stirred at room temperature for 5 h. H₂O (150 mL) was then added and the mixture was extracted with EtOAc (5×100 mL). The combined extraction was washed with brine (200 mL) and dried (MgSO₄). Column chromatography on silica gel (EtOAc) followed by concentration in vacuo yielded diol 4 (2.12 g, 13.1 mmol, 86.2%) as a colourless, transparent liquid. R_{f}=0.69 (EtOAc). Spectral data for 4: ¹H NMR (CDCl₃, 400 MHz): δ 4.30 (ABX₃, 2H), 4.11 (m, 1H), 3.81 (m, 1H), 3.04 (d, 1H, J=5.0 Hz), 1.88 (d, 1H, J=9.2 Hz), 1.65 (ABMX₃, 2H), 1.33 (t, 3H, J=7.2 Hz), 1.02 (t, 3H, J=7.5 Hz). ¹³C NMR (CDCl₃, 100 MHz): δ 174.2, 74.4, 73.5, 62.2, 26.9, 14.4, 10.5. IR (neat, cm⁻¹): 3447 (br, s), 2969 (m), 2939 (m), 2880 (w), 1731 (s), 1462 (w), 1372 (w), 1242 (s), 1208 (s), 1135 (s), 1084 (s), 1047 (s), 1025 (s). [α]_{D}²°=0.862 (c 0.58; CH₂Cl₂). MS (EI, 70 eV): m/z 59, 71, 76 (base peak), 89, 104, 133, 134, 145.

### Acetonide 5

A round-bottomed flask was charged with diol 4 (2.12 g, 13.1 mmol), CH₂Cl₂ (100 mL), 2, 2-dimethoxypropane (2.41 mL, 19.6 mmol) and para-toluenesulfonic acid (212 mg, 1.23 mmol). The reaction was stirred at room temperature for 16 h. NaHCO₃ (2.12 g, 25.2 mmol) was then added, and the reaction mixture was stirred for 30 min, then filtered through alumina and concentrated in vacuo. Column chromatography on silica gel (1:4 EtOAc:Hexanes) followed by concentration in vacuo yielded acetonide 5 (2.56 g, 12.7 mmol, 97%) as a colourless, transparent liquid. R_{f}=0.74 (1:2 EtOAc:Hexanes). Spectral data for 5: ¹H NMR (CDCl₃, 400 MHz): δ 4.24 (ABX₃, 2H), 4.12 (m, 2H), 1.76 (ABMX₃, 2H), 1.47 (s, 3H), 1.45 (s, 3H), 1.30 (t, 3H, J=7.2 Hz), 1.03 (t, 3H, J=7.3 Hz). ¹³C NMR (CDCl₃, 100 MHz): δ 169.6, 109.2, 78.9, 77.4, 59.8, 25.6, 25.0, 24.1, 12.6, 8.3. IR (neat, cm⁻¹): 2984 (m), 2938 (m), 2881 (w), 1758 (s), 1734 (s), 1461 (w), 1371 (s), 1243 (s), 1193 (s), 1095 (s), 1035 (s). [α]_{D}²°=−3.39 (c 0.59; CH₂Cl₂). MS (EI, 70 eV): m/z 59, 71, 87, 99, 127, 129, 144, 187 (base peak).

### Hydroxyacetonide 6

A flame-dried round-bottomed flask was charged with acetonide 5 (2.56 g, 12.7 mmol), THF (120 mL) and cooled to 0° C. LiAlH₄ (1.01 g, 26.6 mmol) was added, and the reaction was stirred at 0° C. for 30 min., then warmed to room temperature and stirred for 1.5 h. The reaction was quenched with H₂O (1 mL), then 1 M aqueous NaOH (1 mL) and H₂O (3 mL) were added. The reaction mixture was stirred until the grey colour disappeared, indicating complete quenching. Filtration through celite, then column chromatography on silica gel (1:1 EtOAc:Hexanes) followed by concentration in vacuo yielded hydroxyacetonide 6 (1.83 g, 11.4 mmol, 90%) as a colourless, transparent liquid. R_{f}=0.35 (1:2 EtOAc:Hexanes). Spectral data for 6: ¹H NMR (CDCl₃, 400 MHz): δ 3.59-3.86 (m, 4H), 2.14 (br s, 1H), 1.62 (ABMX₃, 2H), 1.42 (br s, 6H), 1.09 (t, 3H, J=7.3 Hz). ¹³C NMR (CDCl₃, 100 MHz): δ 108.6, 81.2, 78.1, 62.2, 27.3, 27.0, 25.9, 10.3. IR (neat, cm⁻¹): 3424 (br, m), 2984 (m), 2935 (m), 2879 (m), 1458 (m), 1372 (s), 1242 (s), 1216 (s), 1169 (s), 1101 (s), 1042 (s). [α]_{D}²°=25 (c 0.40; CH₂Cl₂). MS (EI, 70 eV): m/z 59 (base peak), 67, 71, 85, 129, 145.

### Tosyl Acetonide 7

A round-bottomed flask was charged with hydroxyacetonide 6 (1.83 g, 11.4 mmol), Et₂O (100 mL), and the mixture was cooled to −10° C. (ice-salt bath). Powdered KOH (9.58 g, 171 mmol) and TsCl (3.27 g, 17.2 mmol) were then added and the reaction was warmed to 0° C. and stirred at that temperature for 5 h. H₂O was added (50 mL), the layers were separated, and the aqueous layer was extracted with Et₂O (3×50 mL). The combined organic layers were washed with brine (50 mL) and dried (MgSO₄). Column chromatography on silica gel (2:3 EtOAc:Hexanes) followed by concentration in vacuo yielded tosyl acetonide 7 (2.94 g, 9.36 mmol, 82%) as a white solid. R_{f}=0.30 (1:6 EtOAc:Hexanes). Spectral data for 7: ¹H NMR (CDCl₃, 400 MHz): δ 7.80 (AA′XX′, 2H), 7.36 (AA′XX′, 2H), 4.04-4.14 (m, 2H), 3.73-3.82 (ABX, 2H), 2.45 (s, 3H), 1.58 (ABM₃X, 2H), 1.36 (s, 3H), 1.31 (s, 3H), 0.95 (t, 3H, J=7.5 Hz). ¹³C NMR (CDCl₃, 100 MHz): δ 144.9, 132.6, 129.8, 127.9, 109.2, 78.8, 77.7, 69.2, 27.1, 26.6, 25.8, 21.5, 9.8. IR (neat, cm⁻¹): 2981 (m), 2937 (m), 2882 (w), 1598 (w), 1456 (w), 1362 (s), 1244 (m), 1215 (m), 1189 (s), 1175 (s), 1096 (m), 1072 (w). [α]_{D}²°=−8.7 (c 0.87; CH₂Cl₂). MS (EI, 70 eV): m/z 59, 91, 129, 155 (base peak), 213, 227, 299.

### (2R,3S)-2,3-Dihydroxy-1-tosyloxypentane 8

A round-bottomed flask was charged with tosyl acetonide 7 (2.94 g, 9.36 mmol), MeOH (70 mL) and HCl (20 mL, 1.25 M in MeOH, 25 mmol). The reaction was stirred at room temperature for 5 d, then H₂O (50 mL) was added and the reaction mixture was extracted with Et₂O (4×50 mL). The combined Et₂O extractions were washed with brine (100 mL) and dried (MgSO₄). Diol 8 (1.03 g, 3.76 mmol, 40%) was a white solid and was used without further purification. R_{f}=0.16 (1:2 EtOAc:Hexanes). Spectral data for 8: ¹H NMR (CDCl₃, 400 MHz): δ 7.80 (AA′XX′, 2H), 7.36 (AA′XX′, 2H), 4.09 (ABX, 2H), 3.95 (m, 1H), 3.75 (m, 1H), 3.51 (m, 1H), 2.64 (br s, 1H), 2.46 (s, 3H), 1.54 (ABMX₃, 2H), 0.95 (t, 3H, J=7.5 Hz). ¹³C NMR (CDCl₃, 100 MHz): δ 145.2, 132.5, 130.0, 128.0, 72.1, 71.4, 71.1, 26.4, 21.6, 9.9. IR (neat, cm⁻¹): 3386 (m, br), 3271 (m, br), 2942 (w), 1538 (m), 1457 (m), 1353 (s), 1192 (s), 1178 (s), 1096 (m), 1074 (m), 1043 (w). [α]_{D}²°=−8.8 (c 0.17; THF).

### (2S,3S)-1,2-Epoxy-3-hydroxypentane 9

K₂CO₃ (1.04 g, 7.52 mmol) was added to a stirred solution of diol 8 (1.03, 3.76 mmol) in MeOH (40 mL) at room temperature. The reaction was stirred for 16 h. H₂O (40 mL) was added, and the reaction mixture was extracted with Et₂O (3×30 mL). The combined extractions were washed with brine (50 mL) and dried (MgSO₄). Column chromatography on silica gel (EtOAc) followed by concentration in vacuo yielded epoxyalcohol 9 (112 mg, 1.10 mmol, 29%) as a colourless, transparent liquid. R_{f}=0.31 (1:2 EtOAc:Hexanes). Spectral data for 9: ¹H NMR (CDCl₃, 400 MHz): δ 3.38 (m, 1H), 3.01 (m, 1H), 2.83 (dd, 1H, J=4.9, 4.1 Hz), 2.73 (dd, 1H, J=5.0, 2.7 Hz), 1.65 (ABM₃X, 2H), 1.02 (t, 3H, J=7.5 Hz), hydroxyl proton not observed. ¹³C NMR (CDCl₃, 100 MHz): δ 72.9, 55.1, 45.1, 27.4, 9.7. IR (neat, cm⁻¹): 3402 (br, s), 2970 (s), 2933 (s), 2881 (m), 1734 (w), 1460 (m), 1381 (m), 1309 (w), 1254 (s), 1177 (w), 1067 (s), 1036 (m). [α]_{D}²°=9.0 (c 0.31; CH₂Cl₂). MS (EI, 70 eV): m/z 55, 57, 59 (base peak), 73, 84, 102 (M⁺).

### (2S,3S)-1,2-Epoxy-3-tosyloxypentane 10

A round-bottomed flask was charged with epoxyalcohol 9 (112 mg, 1.10 mmol), Et₂O (15 mL), and the mixture was cooled to 0° C. Powdered KOH (924 mg, 16.5 mmol) and TsCl (314 mg, 1.65 mmol) were then added and the reaction was stirred at 0° C. for 5 h. H₂O (15 mL) was added, the layers were separated, and the aqueous layer was extracted with Et₂O (3×20 mL). The combined organic layers were washed with brine (20 mL) and dried (MgSO₄). Column chromatography on silica gel (2:3 EtOAc:Hexanes) followed by concentration in vacuo yielded tosylepoxide 10 (141 mg, 0.550 mmol, 50%) as a white solid. R_{f}=0.16 (1:6 EtOAc:Hexanes). Spectral data for 10: ¹H NMR (CDCl₃, 400 MHz): δ 7.82 (AA′XX′, 2H), 7.34 (AA′XX′, 2H), 4.28 (ABXY, 1H), 3.05 (ddd, 1H, J=6.3, 4.1, 2.7 Hz), 2.78 (dd, 1H, J=4.3, 4.3 Hz), 2.63 (dd, 1H, J=4.8, 2.6 Hz), 2.44 (s, 3H), 1.76 (ABM₃X, 2H), 0.95 (t, 3H, J=7.5 Hz). ¹³C NMR (CDCl₃, 100 MHz): δ 144.6, 134.2, 129.6, 127.8, 84.6, 52.4, 44.7, 25.1, 21.6, 9.4. IR (neat, cm⁻¹): 2972 (w), 2927 (w), 1598 (w), 1458 (w), 1356 (s), 1259 (w), 1174 (s), 1097 (m). [α]_{D}²°=11.0 (c 0.48; CH₂Cl₂). MS (EI, 70 eV): m/z 65, 91, 155 (base peak), 172, 173, 213, 256 (M⁺).

### (3S,4S)-4-Hydroxy-3-tosyloxy-6,9-heptadecadiyne 14

A flame-dried round-bottomed flask was charged with diyne 12 (340 mg, 2.10 mmol), THF (15 mL) and cooled to −78° C. ⁿBuLi (0.84 mL, 2.5 M in Hexanes, 2.10 mmol) was added dropwise over 1 min. and the reaction was stirred for 20 min. at −78° C. BF₃.Et₂O (0.26 mL, 2.11 mmol) was then added and the reaction was stirred for a further 20 min. at −78° C. A solution of tosylepoxide 10 (74.5 g, 0.291 mmol) was then added and the reaction was allowed to warm to room temperature. After stirring for 1 h, the reaction was quenched with H₂O (20 mL) and extracted with Et₂O (4×20 mL). The combined organic layers were washed with brine (30 mL) and dried (MgSO₄). Column chromatography on silica gel (2:3 EtOAc:Hexanes) followed by concentration in vacuo yielded diynol 14 (31.4 mg, 0.0751 mmol, 26%) as a colourless, transparent liquid. R_{f}=0.43 (1:2 EtOAc:Hexanes). Spectral data for 14: ¹H NMR (CDCl₃, 400 MHz): δ 7.83 (AA′XX′, 2H), 7.34 (AA′XX′, 2H), 4.60 (m, 1H), 3.82 (dt, 1H, J=6.0, 4.6 Hz), 3.12 (m, 2H), 2.45 (s, 3H), 2.35 (m, 2H), 2.16 (tt, 2H, J=7.0, 2.4 Hz), 1.28-1.83 (m, 13H), 0.81-0.96 (m, 6H). ¹³C NMR (CDCl₃, 100 MHz): δ 144.8, 134.0, 129.8, 127.9, 85.8, 81.0, 77.9, 75.3, 73.7, 70.0, 31.7, 28.9, 28.8, 28.7, 23.84, 23.81, 22.6, 21.8, 18.7, 14.1, 9.8, 9.5. IR (neat, cm⁻¹): 3389 (br, m), 2955 (m), 2931 (s), 2857 (m), 1716 (m), 1598 (m), 1463 (m), 1363 (s), 1176 (s), 1097 (w). [α]_{D}²°=7.5 (c 0.04; CH₂Cl₂).

### (3R,4S)-3,4-Epoxy-6,9-heptadecadiyne 15

To a stirred solution of diynol 14 (31.4 mg, 0.0751 mmol) in MeOH (5.0 mL) at room temperature was added K₂CO₃ (15.8 mg, 0.114 mmol). The reaction was stirred for 1.5 h. H₂O (10 mL) was added, and the reaction mixture was extracted with Et₂O (3×15 mL).

The combined extractions were washed with brine (20 mL) and dried (MgSO₄). Column chromatography on silica gel (1:4 EtOAc:Hexanes) followed by concentration in vacuo yielded epoxydiyne 15 (4.4 mg, 0.018 mmol, 24%) as a colourless, transparent liquid. R_{f}=0.19 (1:19 EtOAc:Hexanes). Spectral data for 15: ¹H NMR (CDCl₃, 400 MHz): δ 3.12-3.17 (m, 3H), 2.92 (AMX₂, 1H), 2.58 (dm, 1H, J=17.1 Hz), 2.27 (ddt, 1H, J=16.9, 7.3, 2.4 Hz), 2.15 (m, 2H), 1.86 (m, 1H), 1.71 (m, 1H), 1.20-1.64 (m, 10H), 1.07 (t, 3H, J=7.5 Hz), 0.86 (t, 3H, J=7.3 Hz). ¹³C NMR (CDCl₃, 100 MHz): δ 80.9, 75.34, 75.28, 73.9, 58.2, 55.2, 31.8, 29.1, 28.9, 28.8, 28.7, 25.3, 20.9, 18.7, 11.4, 10.5, 9.8. IR (neat, cm⁻¹): 2968 (s), 2927 (s), 2856 (s), 1741 (w), 1458 (m), 1380 (w), 1315 (w), 1261 (w), 1157 (w). [α]_{D}²°=6.3 (c 0.16; CH₂Cl₂). MS (EI, 70 eV): m/z 55, 67, 79, 91 (base peak), 105, 119, 133, 147, 161, 175, 189, 203, 217, 231, 245.

### Z,Z-(3R,4S)-cis-3,4-epoxy-6,9-heptadecadiene 16

A suspension of Ni(OAc)₂.4H₂O (90.0 mg, 0.362 mmol) in EtOH (4.0 mL) was cooled to 0° C. and NaBH₄ (0.40 mL, 1.0 M in EtOH, 0.40 mmol) was added. The reaction flask was purged with vacuum and filled with H₂ (1 atm.). Ethylenediamine ((NH₂CH₂)₂) (0.10 mL, 1.5 mmol) was added, the reaction mixture was stirred for 5 min. at 0° C., then a solution of epoxydiyne 15 (4.4 mg, 0.018 mmol) in EtOH (1 mL) was added via syringe with rinsing (3×1 mL of EtOH), and the reaction was stirred under 1 atm. of H₂ at 0° C. for 25 min. The product was isolated by column chromatography on silica gel (1:9 EtOAc:Hexanes) of the crude reaction mixture to give epoxydiene 16 (4.5 mg, 0.018 mmol, 100%) as a colourless, transparent liquid. R_{f}=0.22 (1:19 EtOAc:Hexanes). Spectral data for 16: ¹H NMR (CDCl₃, 400 MHz): δ 5.29-5.52 (m, 4H), 2.88-2.98 (m, 2H), 2.81 (t, 2H, J=6.7 Hz), 2.19-2.85 (m, 4H), 2.02-2.07 (m, 2H), 1.23-1.62 (m, 10H), 1.06 (t, 3H, J=7.5 Hz), 0.88 (t, 3H, J=7.2 Hz). ¹³C NMR (CDCl₃, 100 MHz): δ 130.8, 130.7, 127.2, 124.2, 58.4, 56.6, 31.9, 29.7, 29.6, 29.3, 29.2, 27.3, 26.2, 25.8, 22.7, 14.1, 10.6. IR (neat, cm⁻¹): 3013 (w), 2956 (m), 2925 (s), 2854 (m), 1733 (w), 1458 (m), 1280 (w), 1074 (w), 1022 (w). [α]_{D}²°=−2.1 (c 0.19; CH₂Cl₂). MS (EI, 70 eV): m/z 55, 67, 79 (base peak), 93, 107, 121, 135, 147, 178, 192, 203, 221, 232, 250 (M⁺). HRMS for 16: ([M⁺] calc. 250.2296. found 250.2303, −2.80 ppm difference).

### Z,Z-(3S,4R)-3,4-epoxy-6,9-heptadecadiene 18

This was synthesized in an identical manner to its (3R,4S)-enantiomer 16, however AD-mix-β (as opposed to AD-mix-α) was used to make diol 17. The specific rotation of 18 was found to be: [α]_{D}²°=2.7 (c 0.55; CH₂Cl₂). All other spectral data for 18 were identical to its enantiomer 16.

For literature optical rotations of these two diene epoxide enantiomers, see: (Millar et al., 1990). They report: [α]_{D}²³=−2.8 (c 2.45; CH₂Cl₂) for 16, and [α]_{D}²³=2.9 (c 2.42; CH₂Cl₂) for 18.

### 1,4-Dodecadiyne 12

This reaction was done according to Millar and Underhill (1986). A flame-dried round-bottomed flask was charged with EtMgBr (2.95 mL of 3.0 M solution in Et₂O, 8.85 mmol), THF (50 mL) and 1-nonyne 11 (1.32 mL, 8.05 mmol). The mixture was heated to 45° C. for 2 h. It was then cooled to −15° C. (ice-salt bath) and CuI (30.0 mg, 0.158 mmol) was added. After stirring for 20 min., propargyl bromide (0.90 mL, 80 wt % in toluene, 8.08 mmol) was added, the reaction was warmed to RT and stirred for 12 h. It was then quenched with H₂O (50 mL) and extracted with hexanes (3×40 mL). The combined organic layers were washed with brine (50 mL) and dried (MgSO₄). Column chromatography on silica gel (hexanes) followed by concentration in vacuo yielded diyne 12 (458 mg, 2.83 mmol, 35%) as a colourless, transparent liquid. R_{f}=0.40 (hexanes). Spectral data for 12: ¹H NMR (CDCl₃, 400 MHz): δ 3.15 (dt, 2H, J=2.4, 2.4 Hz), 2.16 (tt, 2H, J=7.2, 2.4 Hz), 2.06 (t, 1H, J=2.7 Hz), 1.27-1.53 (m, 10H), 0.88 (t, 3H, J=6.7 Hz). ¹³C NMR (CDCl₃, 100 MHz): δ 81.3, 79.0, 72.9, 68.3, 31.7, 28.79, 28.77, 28.6, 22.6, 18.6, 14.0, 9.5. IR (neat, cm⁻¹): 3302 (m), 2955 (s), 2856 (s), 1714 (m), 1686 (m), 1464 (m), 1415 (w), 1378 (w), 1310 (m), 1108 (w). MS (EI, 70 eV): m/z 51, 55, 67, 77, 81, 91 (base peak), 105, 119, 123, 133, 147, 161.

### (Z,Z,Z)-17-Bromo-3,6,9-heptadecatriene 20

Literature reference for Barton decarboxylation/bromination (Loreau et al., 2000). Oxalyl chloride ((COCl)₂), (0.17 mL, 2.0 mmol) and a catalytic amount of DMF (14 μL) were added to a stirred solution of 99% isomerically pure (Z,Z,Z)-linolenic acid 19 (0.55 mL, 1.8 mmol) and CH₂Cl₂ (4 mL). The reaction mixture was left to stir at reflux temperature under an argon atmosphere for 6 hours and then cooled to RT. The solvent was removed under reduced pressure to obtain a yellow liquid (0.569 g) which was not further purified. 4-Dimethylaminopyridine (DMAP) (22 mg, 0.18 mmol), 2-mercaptopyridine N-oxide, sodium salt (0.325 g, 2.18 mmol) and bromotrichloromethane (CBrCl₃) (6.0 mL) were added to an oven-dried RBF with a stir bar and placed under an argon atmosphere. The reaction mixture was heated to reflux temperature and the acyl chloride generated above in CBrCl₃ (4.0 mL) was added drop-wise. The solution was left to heat at reflux for 2 h and was then allowed to cool to RT. The mixture was diluted with diethyl ether (20 mL), then brine (20 mL) was added, the layers were separated and the aqueous layer was extracted with diethyl ether (2×20 mL). The combined organic layers were washed with water (20 mL) and dried (MgSO₄). Column chromatography on silica gel (1:5 EtOAc:Hexanes) followed by concentration in vacuo yielded 20 (347 mg, 1.11 mmol, 62%) as a pale yellow liquid. R_{f}=0.52 (hexanes). Spectral data for 20: ¹H NMR (CDCl₃, 400 MHz): δ 5.32-5.40 (m, 6H), 3.40 (t, 2H, J=8.0 Hz), 2.81, (t, 4H, J=8.0 Hz), 2.07 (m, 4H), 1.85 (m, 2H), 1.30-1.45 (m, 8H), 0.98 (t, 3H, J=8.0 Hz). ¹³C NMR (CDCl₃, 100 MHz): δ 131.9, 130.2, 128.3, 128.2, 127.8, 127.1, 33.9, 32.8, 29.5, 29.1, 28.6, 28.1, 27.2, 25.6, 25.5, 20.5, 14.3. IR (neat, cm¹): 3009 (m), 2962 (m), 2929 (s), 2854 (m), 1460 (m), 1438 (m), 1395 (w), 1251 (m), 1066 (w). MS (EI, 70 eV): m/z 55, 67, 79 (base peak), 93, 95, 108, 121, 135, 149, 201, 256, 258, 283, 285, 312 (M⁺, ⁷⁹Br), 314 (M⁺, ⁸¹Br).

### Z,Z,Z-3,6,9-Heptadecatriene 21

20 (94 mg, 0.30 mmol) and LiAlH₄ (12 mg, 0.32 mmol) were added to THF (1.5 mL) in a flame-dried round-bottomed flask. The reaction mixture was stirred, heated to reflux and placed under an argon atmosphere for 3 h. Then H₂O (0.025 mL, 1M NaOH (0.025 mL) and H₂O (0.075 mL) were successively added to the reaction mixture. After a white solid had formed the mixture was filtered through a pad of Celite using diethyl ether to thoroughly wash the filter pad. The solvent was removed under reduced pressure to yield a light yellow liquid. The crude product was purified by column chromatography on silica gel (hexanes) to give 21 (51.9 mg, 0.222 mmol, 74%) as a colorless liquid. R_{f}=0.74 (hexanes). Spectral data for 21: ¹H NMR (CDCl₃, 400 MHz): δ 5.37 (m, 6H), 2.81 (m, 4H), 2.08 (m, 4H), 1.28 (s, 10H), 0.98 (t, 3H, J=8.0 Hz), 0.88 (t, 3H, J=8.0 Hz). ¹³C NMR (CDCl₃, 100 MHz): δ 132.7, 131.1, 129.0, 129.0, 128.4, 127.9, 32.6, 30.4, 30.0 (2 carbons), 28.0, 26.4, 26.3, 23.4, 21.3, 15.0, 14.8. IR (neat, cm⁻¹): 3012 (m), 2960 (s), 2926 (s), 2855 (s), 1657 (w), 1462 (m), 1384 (m), 1110 (s). MS (EI, 70 eV): m/z 55, 67, 79 (base peak), 93, 108, 121, 135, 149, 163, 178, 191, 204, 234 (M⁺). HRMS for 21: ([M⁺] calc. 234.2347. found 234.2350, −1.28 ppm difference).

### Field Experiments

Field Experiments.

Two field experiments were conducted during the moth flight season in 2012. Traps were deployed in vegetative lowbush blueberry fields located in Farmington (field experiment no. 1) and Debert (field experiment no. 2), Nova Scotia. Lowbush blueberries are typically produced on a biennial cycle. After harvest, plants are pruned and enter a year-long vegetative phase. Fruit do not develop on plants until the following year.

In both field experiments, traps were arranged in a randomized complete block design with ten replicates in the first experiment and six replicates in the second field experiment. Counts of male moths in traps were done twice per week. Trap data were log₁₀ (x+1) transformed to satisfy assumptions of normality and equal variance and were analyzed by ANOVA using Proc Mixed (SAS, 2001). Where significant differences were detected, Fisher's least significant difference (LSD) was used for multiple mean comparisons among treatments.

The first experiment attempted to clarify: (1) whether enantiomers of the tested epoxide compound differed in the ability to attract male I. argillacearia moths; and (2) whether a mixture of the tested epoxide and triene compounds was more attractive to male moths than each constituent alone.

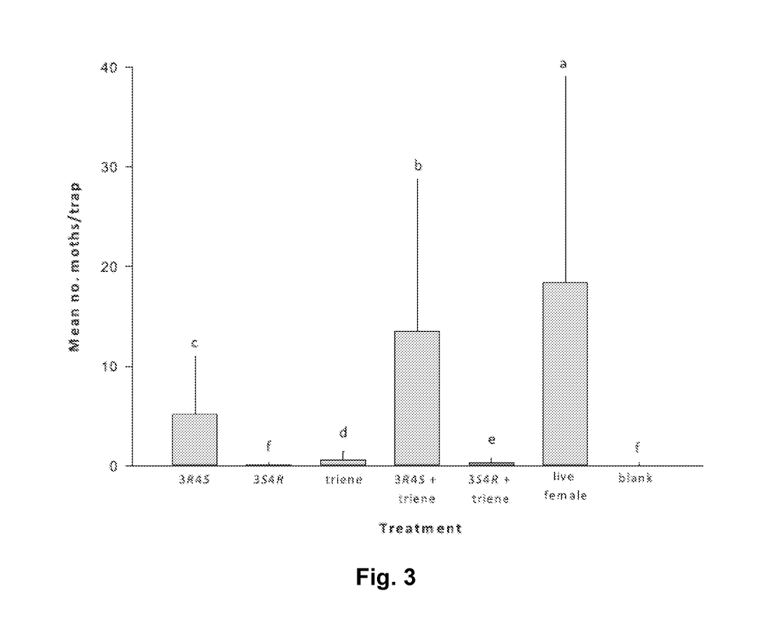

Rubber septa (Wheaton, N.J., USA) loaded with treatments were placed within Delta® traps (Contech, Delta, British Columbia) with sticky inserts to capture moths. Traps were placed approximately 20 m apart (Cantelo et al., 1982; Hillier, 2001; Hillier et al., 2002), and suspended from iron stakes just above the blueberry canopy. The experiment had seven treatments. FIG. 3 shows the mean (±SEM, n=10) trap catches of male I. argillacearia moths in traps with:

(1) cis-3R,4S-epoxy-(Z,Z)-6,9-17:H (50 μg);

(2) cis-3S,4R-epoxy-(Z,Z)-6,9-17:H (50 μg);

(3) (Z,Z,Z)-3,6,9-17:H (50 μg);

(4) cis-3R,4S-epoxy-(Z,Z)-6,9-17:H and (Z,Z,Z)-3,6,9-17:H (50 μg each);

(5) cis-3S,4R-epoxy-(Z,Z)-6,9-17:H and (Z,Z,Z)-3,6,9-17:H (50 μg each);

(6) a one day old virgin female;

(7) blank control trap.

Means followed by the same letter are not significantly different (LSD test, P<0.05).

Virgin female moths were held in 25 ml plastic Solo™ cups (TRA Cash and Carry, Truro, NS, Canada) perforated with approximately 20 5-mm holes. Traps were in the field from 9-26 Jul. 2012 and were emptied or replaced twice per week during this period.

In the first trapping experiment, there was a significant difference in captures of male moths for the different treatments (F_{6,280}=484.04, P<0.0001) (FIG. 3). The effect of block (F_{9,280}=12.11, P<0.0001) and the treatment-block interaction (F_{54,280}=3.88, P<0.0001) were also significant. Traps with live females attracted the greatest number of males. Traps baited with 3R,4S-epoxy-(Z,Z)-6,9-17:H and (Z,Z,Z)-3,6,9-17:H caught approximately 75% of the number of male moth collected in traps with live female. This combination also trapped more males than did 3R,4S-epoxy-(Z,Z)-6,9-17:H or (Z,Z,Z)-3,6,9-17:H alone (FIG. 3). Few moths were recovered from any of the other treatments.

Very few moths were recovered from traps that contained (Z,Z,Z)-3,6,9-17:H alone, and although a significant number of moths were found traps that contained only 3R,4S-epoxy-(Z,Z)-6,9-17:H, over twice as many were collected in traps that contained a mixture of 3R,4S-epoxy-(Z,Z)-6,9-17:H and (Z,Z,Z)-3,6,9-17:H. The lack of captured moths in traps baited with 3S,4R-epoxy-(Z,Z)-6,9-17:H indicate this enantiomer is not an important I. argillacearia pheromone constituent.

Itame occiduaria (Packard) moths have been shown to be attracted to a blend of 3R,4S-epoxy-(Z,Z)-6,9-17:H (225 μg) and (Z,Z,Z)-3,6,9-17:H (50 μg) (Millar, J. G., et al. Synthesis and field testing of enantiomers of 6Z,9Z-cis-3,4-epoxydienes as sex attractants for geometrid moths, interactions of enantiomers and regioisomers. Journal of Chemical Ecology 1990 16:2317-2339). However, although different Itame species may share similar sex pheromone components, it is not possible to predict the actual sex pheromone blends for different Itame species since the actual sex pheromone blends have enantiomeric specificity and different compositions (Millar, J. G. Polyene hydrocarbons and epoxides: a second major class of lepidopteran sex attractant pheromones. Annual Review of Entomology 2000 45:575-604). For example, the 1990 Millar reference teaches that Itame occiduaria was captured by a mixture of 3R,4S-epoxy-(Z,Z)-6,9-17:H (225 μg) and (Z,Z,Z)-3,6,9-17:H (50 μg), but Millar also teaches that Itame brunneata (a moth of the same Itame genus) was captured by the opposite enantiomer (i.e. 3R,4S-epoxy-(Z,Z)-6,9-17:H) and did not require (Z,Z,Z)-3,6,9-17:H in the mixture.

In view of the above, the actual blend of components required to act as a sex pheromone for a given species of insect is inherently unpredictable from the sex pheromones of other insects, even from insects of the same genus. There is no a priori way of predicting what components would work for a given species unless analysis of the insect is carried out.

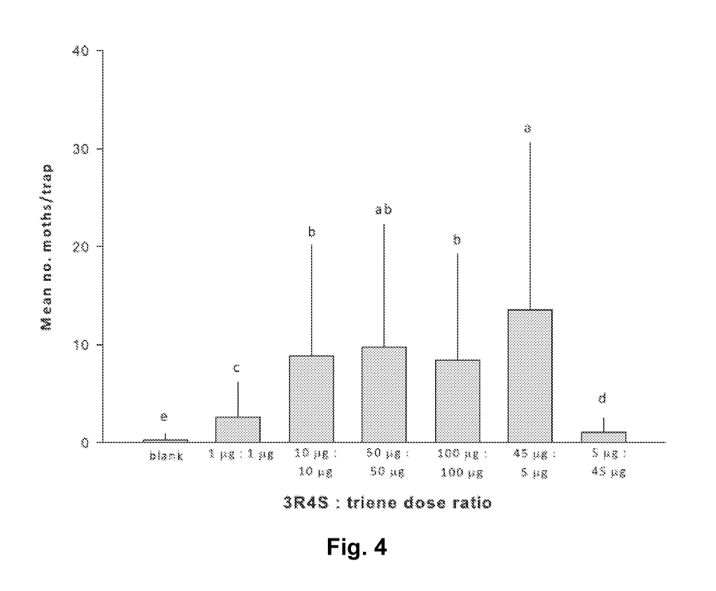

The second field experiment examined the dose-response with 3R,4S-epoxy-(Z,Z)-6,9-17:H and (Z,Z,Z)-3,6,9-17:H. Traps were in the field from 23 July to 3 Aug. 2012 and were emptied or replaced twice per week during this period. FIG. 4 shows the mean number of captures of male I. argillacearia moths in traps baited with: (1) blank lure; (2) 3R,4S-epoxy-(Z,Z)-6,9-17:H and (Z,Z,Z)-3,6,9-17:H (1 μg); (3) 3R,4S-epoxy-(Z,Z)-6,9-17:H and (Z,Z,Z)-3,6,9-17:H (10 μg); (4) 3R,4S-epoxy-(Z,Z)-6,9-17:H and (Z,Z,Z)-3,6,9-17:H (50 μg); (5) 3R,4S-epoxy-(Z,Z)-6,9-17:H and (Z,Z,Z)-3,6,9-17:H (100 μg); (6) 3R,4S-epoxy-(Z,Z)-6,9-17:H (45 μg) and (Z,Z,Z)-3,6,9-17:H (5 μg); (7) 3R,4S-epoxy-(Z,Z)-6,9-17:H (5 μg) and (Z,Z,Z)-3,6,9-17:H (45 μg). Means followed by the same letter are not significantly different (LSD test, P<0.05)

In the second trapping experiment, pheromone dose had a significant effect on the mean number of males caught per trap (F₆₁₂₆=69.24, P<0.0001) (FIG. 4). The highest trap captures were observed when 3R,4S-epoxy-(Z,Z)-6,9-17:H and (Z,Z,Z)-3,6,9-17:H was in a 9:1 ratio (45:5 μg/μg), where there was a 25% increase in moth captures compared to treatments with equivalent amounts of 3R,4S-epoxy-(Z,Z)-6,9-17:H and (Z,Z,Z)-3,6,9-17:H at a range of 10-100 μg. The effect of experimental block was significant (F_{5,126}=3.29, P=0.008), but there was no treatment-block interaction (F_{30,126}=1.14, P=0.306).

In a 1:1 ratio, doses of the 3R,4S-epoxy-(Z,Z)-6,9-17:H and (Z,Z,Z)-3,6,9-17:H from 10-100 μg captured equal numbers of moths. When 3R,4S-epoxy-(Z,Z)-6,9-17:H and (Z,Z,Z)-3,6,9-17:H were presented in a 9:1 ratio (45:5 μg/μg), a 30% increase in moth captures was observed, although this was not significantly different than moths captured with traps baits with 50 μg of each constituent.

In the preceding description, for purposes of explanation, numerous details are set forth in order to provide a thorough understanding of the examples. However, it will be apparent to one skilled in the art that these specific details are not required. The above-described examples are intended to be exemplary only. Alterations, modifications and variations can be effected to the particular examples by those of skill in the art without departing from the scope, which is defined solely by the claims appended hereto.

### REFERENCES

AAFC. 2012. Statistical Overview of the Canadian Blueberry Industry, 2010. Market Analysis and Information Section, Horticulture and Special Crops Division, Agriculture and Agri-Food Canada.
ALFORD, A. R. and DIEHL, J. R. 1985. The periodicity of female calling in the blueberry spanworm, Itame argillacearia Pack. (Lepidoptera: Geometridae). Can. Entomol. 117:553-556.
BLACKMER, J. L., RODRIGUEZ-647 SAONA, C., BYERS, J. A., SHOPE, K. L., BYERS, J. A., SHOPE, K. L., and SMITH, J. P. 2004. Behavioral response of (Lygus hesperus) to conspecifics and headspace volatiles in a Y-tube olfactometer. J. Chem. Ecol. 30:288-292.
BOO, K. S., CHUNG, I. B., HAN, K. S., PICKETT, J. A., and WADHA, L. J. 1998. Response of the lacewing (Chrysopa cognate) to pheromones of its aphid prey. J. Chem. Ecol. 24:1333-1339.
BUTT, B. A. and CANTU, E. 1962. Sex determination of lepidopterous pupae. U.S. Dept. of Agriculture, Agricultural Research Service, ARS-33-75.
CANTELO, W. W., JACOBSEN, M., and HARTSTACK, A. W. 1982. Moth trap performance: Jackson trap vs. Texas pheromone trap. Southwest. Entomol. 7:212-215.
CARDÉ, R. T. and BELL, W. J. (eds.). 1995. Chemical Ecology of Insects. Chapman Hall, New York.
CHEN, L. and FADAMIRO, H. Y. 2007. Differential electroantennogram response of females and males of two parasitoid species to host-related green leaf volatiles and inducible compounds. Bull. Entomol. Res. 97:515-522.
CROZIER, L. 1995. The Blueberry Spanworm. Lowbush Blueberry Fact Sheet. Nova Scotia Department of Agriculture and Marketing, Truro.
DRUMMOND, F. A. and GRODEN, E. 2000. Evaluation of entomopathogens for biological control of insect pests of lowbush (wild) blueberry. Technical bulletin-172. University of Maine, Cooperative Extension.
DU, Y., GUY, M., POPPY, WILD, P., JOHN, A. P., LESTER, J. W., and CHRISTINE, M. W. 1998. Identification of semiochemical released during aphid feeding that attract parasitoid (Aphidius ervi). J. Chem. Ecol. 24:679-684.
DUNKELBLUM, E., TAN, S. H., and SILK, P. J. 1985. Double bond location in monounsaturated fatty acids by dimethyldisulfide derivatization and mass spectrometry: application to analysis of fatty acids in pheromone glands of four lepidoptera. J. Chem. Ecol. 11:265-277.
GIBB, A. R., COMESKY, D., BERNDT, L., BROCKERHOFF, E. G., EL-SAYED, A. M., JACTEL, H., and SUCKLING, D. M. 2006. Identification of sex pheromone components of a New Zealand geometrid moth, the common forest looper Pseudocoremia suavis, reveals a possible species complex. J. Chem. Ecol. 32:865-879.
GRIES, R., GRIES, G., SCHAEFER, P. W., GOTOH, T., and HIGASHIURA, Y. 1999. Sex pheromone components of the pink gypsy moth, Lymantria mathura. Naturwissenschaften 86:235-238.
HILLIER, N. K. 2001. Quantitative chemical ecology of the lingonberry fruitworm, Grapholita libertina Heinr. PhD dissertation. Memorial University, St. John's.
HILLIER, N. K., DIXON, P. L., SEABROOK, W. D., and LARSON, D. J. 2002. Field testing of synthetic attractants for male Grapholita libertine (Lepidoptera: Tortricidae). Can. Entomol. 134:657-665.
JUTSUM, A. R. and GORDON, R. F. S. (eds.). 1989. Insect Pheromones in Plant Protection. John Wiley & Sons, New York.
LOREAU, O., MARET, A., POULLAIN, D., CHARDIGNY, J. M., SÉBÉDIO, J. L., BEAUFRÉRE, B., and NOEL, J. P. 2000. Large-scale preparation of (9Z,12E)-[1-13C]-octadeca-9,12-dienoic acid, (9Z,12Z,15E)-[1-13C]-octadeca-9,12,15-trienoic acid and their [1-13C] all-cis isomers. Chem. Phys. Lipids 106:65-78.
MARTIN, J. S., FREDRIK, O., TOM, E. B., ANNA, N., FREDRIK, A., ERIC, H., MICHAEL, J. L., and FLORIAN, P. S. 2004. Identification, synthesis and activity of sex pheromone gland components of the autumn gum moth (Lepidoptera: Geometridae), a defoliator of Eucalyptus. Chemoecology 14:217-223.
MCNEIL, J. N. 1991. Behavioral ecology of pheromone-mediated communication in moths and its importance in the use of pheromone traps. Annu. Rev. Entomol. 36:407-430.
MILLAR, J. G. 2000. Polyene hydrocarbons and epoxides: a second major class of lepidopteran sex attractant pheromones. Annu. Rev. Entomol. 45:575-604.
MILLAR, J. G., GIBLIN, M., BARTON, D., MORRISON, A., and UNDERHILL, E. W. 1990. Synthesis and field testing of enantiomers of 6Z,9Z-cis-3,4-epoxydienes as sex attractants for geometrid moths, interactions of enantiomers and regioisomers. J. Chem. Ecol. 16:2317-2339.
MILLAR, J. G. and UNDERHILL, E. W. 1986. Short synthesis of 1,3Z,6Z,9Z-tetraene hydrocarbons. Lepidopteran sex attractants. Can. J. Chem. 64:2427-2430.
RAMANAIDU, K., HARDMAN, J. M., PERCIVAL, D. C., and CUTLER, G. C. 2011. Laboratory and field susceptibility of blueberry spanworm (Lepidoptera: Geometridae) to conventional and reduced-risk insecticides. Crop Prot. 30:1643-1648.
RYALL, K., SILK, P. J., WU, J., MAYO, P., LEMAY, M. A., and MAGEE, D. 2010. Sex pheromone chemistry and field trapping studies of the elm spanworm Ennomos subsignaria (Hübner) (Lepidoptera: Geometridae). Naturwissenschaften 97:717-724.
SAS. 2001. SAS System for Windows (Version Release 9.1.2). SAS Institute, Raleigh.
SILK, P. J., SWEENEY, J., WU, J., PRICE, J., GUTOWSKI, J. M., and KETTELA, E. G. 2007. Evidence for a male-produced pheromone in Tetropium fuscum (F.) and Tetropium cinnamopterum (Kirby) (Coleoptera: Cerambycidae) Naturwissenschaften 94:697-701.
TURNER, J. C. L. and LIBURD, 0. E. 2007. Insect Management in Blueberries in the Eastern United States. Dept. of Entomology and Nematology, Florida Cooperative Extension Service, Institute of Food and Agricultural Sciences, University of Florida. Report No. ENY-411.
WAGNER, D. L., FERGUSON, D. C., MCCABE, T. L., and REARDON, R. C. 2001. Geometrid caterpillars of northeastern and Appalachian forests. Forest Health Technology Enterprise Team, United States Department of Agriculture, Forest Service. Report No. FHTET-2001-10.
WITZGALL, P., KIRSCH, P., and CORK, A. 2010. Sex pheromones and their impact on pest management. J. Chem. Ecol. 36:80-100.
YAMAMOTO, M., KISO, M., YAMAZAWA, H., TAKEUCHI, J., and ANDO, T. 2000. Identification of chiral sex pheromone secreted by giant geometrid moth, Biston robustum Butler. J. Chem. Ecol. 26:2579-2590.
YANG, F.-L., ZHU, F., and LEI, C.-L. 2011. Insecticidal activities of garlic substances against adults of grain moth, Sitotroga cerealella (Lepidoptera: Gelechiidae). J. Insect Sci. 39:1-8.

What is claimed is:

1. A method of attracting male blueberry spanworm moths, the method comprising:
applying a composition comprising Z,Z-(3R,4S)-cis-3,4-epoxy-6,9-heptadecadiene and Z,Z,Z-3,6,9-heptadecatriene to at least a portion of, or suitably close to, a field having the blueberry spanworm moths, eggs, larva, or any combination thereof.

2. The method according to claim 1, wherein the Z,Z-(3R,4S)-cis-3,4-epoxy-6,9-heptadecadiene and the Z,Z,Z-3,6,9-heptadecatriene are present in a ratio of between 5:1 (by mass) and about 20:1 (by mass).

3. The method according to claim 1, wherein the Z,Z-(3R,4S)-cis-3,4-epoxy-6,9-heptadecadiene and the Z,Z,Z-3,6,9-heptadecatriene are present in a ratio of between about 8:1 (by mass) and about 15:1 (by mass).

4. The method according to claim 1, wherein the Z,Z-(3R,4S)-cis-3,4-epoxy-6,9-heptadecadiene and the Z,Z,Z-3,6,9-heptadecatriene are present in a ratio of about 9:1 (by mass).

5. A method of disrupting blueberry spanworm moth mating, the method comprising:
applying a composition comprising Z,Z-(3R,4S)-cis-3,4-epoxy-6,9-heptadecadiene and Z,Z,Z-3,6,9-heptadecatriene to at least a portion of, or suitably close to, a field that has blueberry spanworm moths, eggs, larva, or any combination thereof, in an amount sufficient to disrupt a male blueberry spanworm moth's ability to locate an emitting female blueberry spanworm moth.

6. The method according to claim 5, wherein the Z,Z-(3R,4S)-cis-3,4-epoxy-6,9-heptadecadiene and the Z,Z,Z-3,6,9-heptadecatriene are present in a ratio of between 5:1 (by mass) and about 20:1 (by mass).

7. The method according to claim 5, wherein the Z,Z-(3R,4S)-cis-3,4-epoxy-6,9-heptadecadiene and the Z,Z,Z-3,6,9-heptadecatriene are present in a ratio of between about 8:1 (by mass) and about 15:1 (by mass).

8. The method according to claim 5, wherein the Z,Z-(3R,4S)-cis-3,4-epoxy-6,9-heptadecadiene and the Z,Z,Z-3,6,9-heptadecatriene are present in a ratio of about 9:1 (by mass).
